(19) United States
(12) Patent Application Publication
(10) Pub. No.: US 2009/0253837 A1
(43) Pub. Date: Oct. 8, 2009

(54) Flame Retardant Polyester Resin Composition

(75) Inventors: Kazuyuki Takagi, Osaka (JP); Noriyuki Suzuki, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: Kaneka Corporation, Osaka (JP)

(21) Appl. No.: 11/887,435

(22) PCT Filed: Mar. 30, 2006
(86) PCT No.: PCT/JP2006/306660

§ 371 Date: Sep. 28, 2007

(30) Foreign Application Priority Data
Mar. 31, 2005 (JP) 2005-104781

(51) Int. Cl. C08K 5/5313; C08K 5/3492

(52) U.S. Cl. 524/102; 524/117

(57) ABSTRACT

The present invention provides a flame retardant polyester resin composition that is free from halogen and can have a high level of initial flame retardancy and maintain flammability even after a long-term heat aging test. By allowing an organophosphorous flame retardant (B) represented by the general formula (1) below:

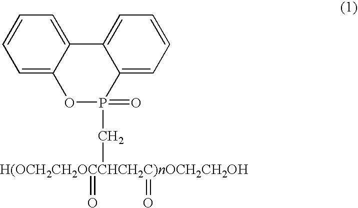

(where n=2 to 20)
   and a nitrogen compound (C) to be contained at a specific ratio with respect to a thermoplastic polyester resin (A), it is possible to obtain a flame retardant polyester resin composition that can have a high level of initial flame retardancy and maintain flammability even after a long-term heat aging test.

### TECHNICAL FIELD

The present invention relates to a flame retardant polyester resin that does not contain a bromine-based or chlorine-based flame retardant or an antimony compound and is excellent in initial flame retardancy and in maintenance of flammability after a long-term heat aging.

### BACKGROUND ART

Due to their excellent properties, thermoplastic polyester resins represented by polyalkylene terephthalate are used widely in electric and electronic components, automotive parts, etc. In recent years, especially for household electric appliances, electric components and parts for OA equipment, a high level of flame retardancy often is demanded in order to provide safety against fire. Accordingly, the blending of various flame retardants has been studied.

When providing the thermoplastic polyester resins with flame retardancy, a halide-based flame retardant generally has been used as a flame retardant in combination with, if necessary, a flame retardant auxiliary such as antimony trioxide, thereby obtaining a resin composition having a high level of flame retardant effect, excellent mechanical strength, excellent heat resistance, etc. However, due to upcoming regulations for the halide-based flame retardants mainly in products to be shipped overseas, studies have been conducted to develop flame retardants free from halogen.

As to the study using phosphorous flame retardants, there is a technology (see JP 53 (1978)-128195 B) related to a resin composition containing an organophosphorous flame retardant and a thermoplastic polyester resin, which has the same structure as that in the present application. This patent discloses that it is possible to achieve flame retardancy rated UL94 V-1 or V-0 in a 3.2 mm thick compression molded article using a polybutylene terephthalate resin.

However, in recent years, especially for household electric appliances, electric components and parts for OA equipment, while a high level of flame retardancy has been demanded in order to provide safety against fire, products themselves have become miniaturized. That is to say, even very thin molded articles such as those having a thickness of 1/16 inch need to meet the UL94 V-0 rating and, at the same time, to have a mechanical property and a heat resistance that are useful as a heat-resistant structure. Also, in terms of a long-term reliability of a product, it also is required to maintain V-0 flammability at 1/16 inch thickness even after a heat aging test at 160° C. for 500 hours as a long-term heat-resistance accelerated test, for example. The above-noted patent has not been able to meet these needs and has been unsatisfactory at present.

### DISCLOSURE OF INVENTION

With the foregoing in mind, it is an object of the present invention to provide a polyester resin composition that is capable of achieving the UL94 V-0 rating even in very thin molded articles such as those with a thickness of 1/16 inch and further maintaining the UL94 V-0 flammability at 1/16 inch thickness even after a heat aging test at 160° C. for 500 hours.

In order to achieve the above-mentioned object, the inventors of the present invention conducted keen studies and finally completed a flame retardant polyester resin composition that had flame retardancy with excellent initial flammability and long-term reliability by allowing an organophosphorous flame retardant (B) having a specific structure and a nitrogen compound (C) to be contained at a specific ratio with respect to a thermoplastic polyester resin (A).

In other words, the present invention relates to a flame retardant polyester resin composition containing 10 to 80 parts by weight of an organophosphorous flame retardant (B) represented by the general formula (1) below:

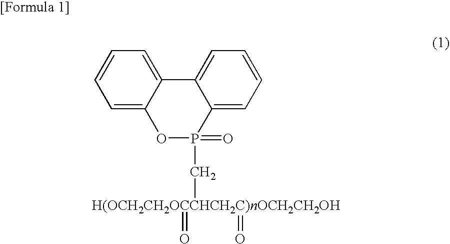

(where n=2 to 20)

and 10 to 100 parts by weight of a nitrogen compound (C) with respect to 100 parts by weight of a thermoplastic polyester resin (A). The flame retardant polyester resin composition has UL94 V-0 flame retardancy rating at 1/16 inch thickness.

It is preferable to have UL94 V-0 flame retardancy rating at 1/16 inch thickness after a heat treatment at 160° C. for 500 hours.

It is preferable that the thermoplastic polyester resin (A) is a polyalkylene terephthalate resin.

It is preferable that the polyalkylene terephthalate resin is a polyethylene terephthalate resin.

Further, the present invention also relates to a resin molded article containing the above-described flame retardant polyester resin composition.

### DESCRIPTION OF THE INVENTION

The present invention relates to a flame retardant polyester resin composition containing 10 to 80 parts by weight of an organophosphorous flame retardant (B) represented by the general formula (1) below:

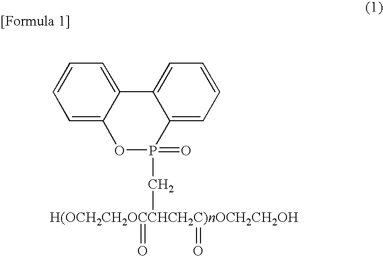

(where n=2 to 20)

and 10 to 100 parts by weight of a nitrogen compound (C) with respect to 100 parts by weight of a thermoplastic polyester resin (A). The flame retardant polyester resin composition has UL94 V-0 flame retardancy rating at 1/16 inch thickness.

The thermoplastic polyester resin (A) used in the present invention refers to a saturated polyester resin obtained by using a divalent acid such as a terephthalic acid or a derivative thereof having an ester forming ability as an acid component and glycol having 2 to 10 carbon atoms, other dihydric alcohols or a derivative thereof having an ester forming ability as a glycol component. Among them, a polyalkylene terephthalate resin is preferable because of its excellent balance of processability, mechanical properties, electrical properties, heat resistance, etc. Specific examples of the polyalkylene terephthalate resin include a polyethylene terephthalate resin, a polybutylene terephthalate resin, and a polyhexamethylene terephthalate resin. Among them, a polyethylene terephthalate resin is particularly preferable because of its excellent heat resistance and chemical resistance.

As necessary, the thermoplastic polyester resin (A) used in the present invention can be copolymerized with other components such that the ratio of the other components to the thermoplastic polyester resin preferably is not greater than 20 parts by weight and particularly preferably is not greater than 10 parts by weight to 100 parts by weight. The component to be copolymerized can be a known acid, alcoholic and/or phenolic component or a derivative thereof having an ester forming ability.

The copolymerizable acid component can be, for example, aromatic carboxylic acids with a valence of at least 2 having 8 to 22 carbon atoms, aliphatic carboxylic acids with a valence of at least 2 having 4 to 12 carbon atoms, alicyclic carboxylic acids with a valence of at least 2 having 8 to 15 carbon atoms, and derivatives thereof having an ester forming ability. Specific examples of the copolymerizable acid component can include terephthalic acid, isophthalic acid, naphthalenedicarboxylic acid, bis(p-carbodiphenyl)methaneanthracenedicarboxylic acid, 4-4′-diphenylcarboxylic acid, 1,2-bis(phenoxy)ethane-4,4′-dicarboxylic acid, 5-sodium sulfoisophthalic acid, adipic acid, sebacic acid, azelaic acid, dodecanedioic acid, maleic acid, trimesic acid, trimellitic acid, pyromellitic acid, 1,3-cyclohexanedicarboxylic acid, 1,4-cyclohexanedicarboxylic acid, and derivatives thereof having an ester forming ability. They are used alone or in combination of two or more. Among them, terephthalic acid, isophthalic acid and naphthalenedicarboxylic acid are preferable because the resultant resin achieves excellent physical properties, handleability and reactivity.

The copolymerizable alcoholic and/or phenolic component can be, for example, aliphatic alcohols with a valence of at least 2 having 2 to 15 carbon atoms, alicyclic alcohols with a valence of at least 2 having 6 to 20 carbon atoms, aromatic alcohols or phenols with a valence of at least 2 having 6 to 40 carbon atoms, and derivatives thereof having an ester forming ability.

Specific examples of the copolymerizable alcoholic and/or phenolic component can include compounds such as ethylene glycol, propanediol, butanediol, hexanediol, decanediol, neopentylglycol, cyclohexanedimethanol, cyclohexanediol, 2,2′-bis(4-hydroxyphenyl)propane, 2,2′-bis(4-hydroxycyclohexyl)propane, hydroquinone, glycerin, pentaerythritol, and derivatives thereof having an ester forming ability, and cyclic esters such as ε-caprolactone. Among them, ethylene glycol and butanediol are preferable because the resultant resin achieves excellent physical properties, handleability and reactivity.

Further, polyalkylene glycol units may be copolymerized partially. Specific examples of such polyalkylene glycol can include polyethylene glycol, polypropylene glycol, polytetramethylene glycol, and random or block copolymers thereof, modified polyoxyalkylene glycol such as alkylene glycol (polyethylene glycol, polypropylene glycol, polytetramethylene glycol, and random or block copolymer thereof, or the like) adducts of bisphenol compounds, etc. Among them, bisphenol A type polyethylene glycol adducts having a molecular weight of 500 to 2000 are preferable because the thermal stability during copolymerization is favorable and the heat resistance of a molded article to be obtained from the resin composition according to the present invention does not decrease easily.

The above-described thermoplastic polyester resins (A) may be used alone or in combination of two or more.

The thermoplastic polyester resins (A) in the present invention can be manufactured by a known polymerization method, for example, melt polycondensation, solid phase polycondensation, solution polymerization or the like. Also, in order to improve the color of the resin during polymerization, one kind or two or more kinds of compounds such as phosphoric acid, phosphorous acid, hypophosphorous acid, monomethyl phosphate, dimethyl phosphate, trimethyl phosphate, methyldiethyl phosphate, triethyl phosphate, triisopropyl phosphate, tributyl phosphate and triphenyl phosphate may be added.

Moreover, in order to raise the degree of crystallinity of the obtained thermoplastic polyester resin, one kind or two or more kinds of various well-known inorganic or organic crystal nucleators may be added during the polymerization.

The intrinsic viscosity (measured at 25° C. in a mixed solution of phenol and tetrachloroethane in a weight ratio of 1:1) of the thermoplastic polyester resin (A) used in the present invention preferably is 0.4 to 1.2 dl/g and more preferably is 0.6 to 1.0 dl/g. The mechanical strength and the shock resistance tend to decrease when the above-noted intrinsic viscosity is smaller than 0.4 dl/g, whereas the flowability at the time of molding tends to decrease when it is larger than 1.2 dl/g.

The organophosphorous flame retardant (B) used in the present invention is represented by the general formula (1) below:

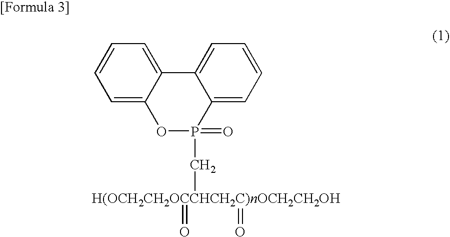

(where n=2 to 20)

contains a phosphorus atom in its molecule, and the lower limit of a repeating unit of n is n=2, preferably is n=3 and particularly preferably is n=5. The lower limit smaller than n=2 tends to inhibit the crystallization of the polyester resin and reduce the mechanical strength. On the other hand, although there is no particular limitation to the upper limit of the repeating unit of n, an excessively high molecular weight tends to affect a dispersion property and the like adversely. Accordingly, the upper limit of the repeating unit of n is n=20, preferably is n=15 and particularly preferably is n=13.

The organophosphorous flame retardant (B) used in the present invention is manufactured by any methods without particular limitation and can be obtained by a general polycondensation reaction, for example, by the following method.

That is, in 9,10-dihydro-9-oxa-10-phosphaphenanthrene-10-oxide represented by the general formula (2) below

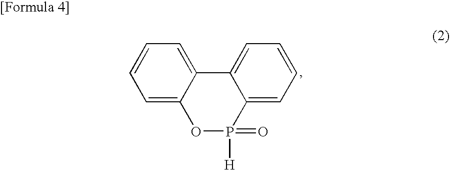

an equimolar amount of itaconic acid and ethylene glycol with at least twice as many moles as the itaconic acid are mixed, heated in a nitrogen atmosphere at 120° C. to 200° C., followed by stirring, thus obtaining a phosphorous flame retardant solution. Antimony trioxide and zinc acetate are added to the obtained phosphorous flame retardant solution, held in a vacuum reduced pressure at not greater than 1 Torr at 220° C., thus allowing a polycondensation reaction to occur while distilling ethylene glycol. When the distillation amount of ethylene glycol drops sharply after about 5 hours, it is considered that the reaction has stopped, and the polycondensation reaction is continued for about 5 hours. With these conditions, it is possible to obtain the organophosphorous flame retardant (B), which is a solid having a molecular weight of 4000 to 12000 and whose phosphorus content is about 8%.

The lower limit of the content of the organophosphorous flame retardant (B) in the flame retardant polyester resin composition according to the present invention preferably is 10 parts by weight, more preferably is 20 parts by weight and further preferably is 30 parts by weight with respect to 100 parts by weight of the thermoplastic polyester resin. When the lower limit of the content of the organophosphorous flame retardant (B) is equal to or smaller than 10 parts by weight, the flame retardancy tends to decrease. The upper limit of the content of the organophosphorous flame retardant (B) preferably is 80 parts by weight and more preferably is 70 parts by weight. When the upper limit of the content of the organophosphorous flame retardant (B) exceeds 80 parts by weight, the mechanical strength decreases, and the moldability tends to deteriorate as well.

The present invention is characterized by an addition of the nitrogen compound (C) in order to raise the flame retardancy further. Examples of the nitrogen compound (C) in the present invention can include melamine cyanuric acid adducts, triazine compounds and tetrazole compounds, etc. of melamine, cyanuric acid and the like. Alternatively, melam and/or melem, which are a dimer and/or a trimer of melamine, can be used. Among them, melamine cyanuric acid adducts are preferable in terms of mechanical strength.

The melamine cyanuric acid adducts in the present invention refer to compounds formed of melamine (2,4,6-triamino-1,3,5-triazine) and cyanuric acid (2,4,6-trihydroxy-1,3,5-triazine) and/or its tautomer.

The melamine cyanuric acid adducts can be obtained by a method of mixing a melamine solution and a cyanuric acid solution so as to form a salt, a method of adding and dissolving one of the solution into the other so as to form a salt, or the like. Although there is no particular limitation on the mixture ratio of the melamine and the cyanuric acid, a ratio closer to an equimolar ratio is more appropriate, and an equimolar ratio is particularly preferable, because the resultant adduct does not impair the thermal stability of the thermoplastic polyester resin.

Although the mean particle diameter of the melamine cyanuric acid adducts in the present invention is not particularly limited, it preferably is 0.01 to 250 μm and particularly preferably is 0.5 to 200 μm, because it does not impair the strength property and molding processability of the resultant composition.

The lower limit of the content of the nitrogen compound (C) in the flame retardant polyester resin composition according to the present invention preferably is 10 parts by weight, more preferably is 20 parts by weight and further preferably 30 parts by weight with respect to 100 parts by weight of the thermoplastic polyester resin. The lower limit of the content of the nitrogen compound (C) smaller than 10 parts by weight tends to reduce the flame retardancy and tracking resistance. The upper limit of the content of the nitrogen compound (C) preferably is 100 parts by weight and more preferably is 80 parts by weight. When the upper limit of the content of the nitrogen compound (C) exceeds 100 parts by weight, the extrusion processability tends to deteriorate or the strength of a welded portion, mechanical strength and moisture and heat resistance tend to decrease.

The flame retardant polyester resin composition according to the present invention can achieve a high level of flame retardancy in a very thin molded article.

The flame retardant polyester resin composition according to the present invention preferably has a UL94 rating of V-0 at a 1/16 inch thickness and more preferably has a UL94 rating of V-0 at a 1/32 inch thickness.

In the uses described later, the molded article formed of the flame retardant polyester resin composition according to the present invention preferably maintains flame retardancy after a long-term heat aging test because it is considered particularly important for the molded article to maintain its flammability and external surface appearance even when it is used in a heat exposure environment for a long time.

In the flame retardant polyester resin composition according to the present invention, the flame retardancy rated UL94 V-0 at a 1/16 inch thickness is maintained after a heat aging test preferably at 160° C. for 500 hours, more preferably at 180° C. for 500 hours and further preferably at 200° C. for 500 hours.

In the case where V-0 cannot be maintained at the time when 500 hours have elapsed at 160° C., the long-term reliability for use in the resin molded article sometimes is suffered.

It is possible to add additives such as glass fibers, an inorganic filler, a pigment, a thermal stabilizer and a lubricant to the flame retardant polyester resin composition according to the present invention, as necessary.

The glass fibers can be any known glass fibers that are in general use but preferably are chopped strand glass fibers treated by a bundling agent in terms of workability.

In order to enhance the close contact between the resin and the glass fibers, the glass fibers used in the present invention preferably are those obtained by treating glass fiber surfaces with a coupling agent and may be those with a binder. The above-noted coupling agent preferably is an alkoxysilane compound such as γ-aminopropyltriethoxysilane or γ-glycidoxypropyltriethoxysilane, and the binder preferably is epoxy resin, urethane resin or the like, though there is no limitation to them.

The above-described glass fibers may be used alone or in combination of two or more. The glass fibers preferably have a fiber diameter of 1 to 20 μm and preferably have a fiber length of 0.01 to 50 mm. The fiber diameter smaller than 1 μm tends to lose an expected reinforcing effect even if these fibers are added, whereas the fiber diameter exceeding 20 μm tends to damage the surface nature of the molded article and the flowability. Further, the fiber length smaller than 0.01 mm tends to lose an expected reinforcing effect even if these fibers are added, whereas the fiber length exceeding 50 mm tends to damage the surface nature of the molded article and the flowability.

The lower limit of the content of the glass fibers in the present invention preferably is 5 parts by weight, more preferably is 10 parts by weight and further preferably is 15 parts by weight with respect to 100 parts by weight of the thermoplastic polyester resin. When the content is smaller than 5 parts by weight, the mechanical strength and the heat resistance tend to be insufficient. The upper limit thereof preferably is 100 parts by weight, more preferably is 90 parts by weight and further preferably is 80 parts by weight. When it exceeds 100 parts by weight, the surface nature of the molded article and the extrusion processability suffer.

The inorganic filler used in the present invention is not particularly limited as long as it is a fibrous and/or granular inorganic filler. The addition of the inorganic filler makes it possible to improve the strength, stiffness, heat resistance, etc. considerably.

Specific examples of the inorganic filler used in the present invention can include carbon fibers, metallic fibers, aramid fibers, asbestos, potassium titanate whiskers, wollastonite, glass flakes, glass beads, talc, mica, clay, calcium carbonate, barium sulfate, titanium oxide, aluminum oxide and the like. Among them, it is preferable to use granular filler, in particular, talc in order to achieve excellent electrical properties, in particular, excellent tracking resistance.

The lower limit of the content of the inorganic filler in the present invention preferably is 1 part by weight, more preferably is 3 parts by weight and further preferably is 5 parts by weight with respect to 100 parts by weight of the thermoplastic polyester resin. When the content of the inorganic filler is smaller than 1 part by weight, there is a tendency for the effects of improving the electrical properties, stiffness, etc. not to be obtained easily. The upper limit thereof preferably is 60 parts by weight, more preferably is 40 parts by weight and further preferably is 20 parts by weight. The content of the inorganic filler exceeding 60 parts by weight sometimes damages the surface nature and mechanical properties of the molded article, the extrusion processability, and the flowability at the time of molding.

The thermal stabilizer can be, for example, bisphenol A diglycidyl ether, butyl glycidyl ether, bis(2,6-di-t-butyl-4-methylphenyl)pentaerythritoldiphosphite, tris(2,4-di-t-butylphenyl)phosphite, 2,2-methylene bis(4,6-di-t-butylphenyl)octylphosphite, pentaerythritoltetrakis[3-(3,5-di-t-butyl-4-hydroxyphenyl)propionate], or the like. The blend amount of the thermal stabilizer preferably is 0.1 to 3.0 parts by weight and more preferably is 0.5 to 1.5 parts by weight with respect to 100 parts by weight of the thermoplastic polyester resin. The blended amount of the thermal stabilizer smaller than 0.1 part by weight sometimes reduces the mechanical properties due to heat deterioration during processing, whereas that exceeding 3.0 parts by weight sometimes brings about gas generation or mold contamination at the time of molding.

Further, the pigment can be a commercially available pigment, for example, carbon black or titanium oxide. The lubricant can be, for example, a polycondensate of ethylenediamine, stearic acid, sebacic acid and the like, or ester of montanoic acid or the like.

The method for manufacturing the flame retardant polyester resin composition according to the present invention is not particularly limited but can be, for example, a method of melting and kneading the polyester resin (A), the organophosphorous flame retardant (B) and the nitrogen compound (C) using various general kneaders. Examples of the kneaders include a single screw extruder, a twin screw extruder and the like, and a twin screw extruder is particularly preferable because of its high kneading efficiency.

Furthermore, the present invention also relates to a resin molded article containing the above-described flame retardant polyester resin composition. The above-noted resin molded article may be formed entirely of or may partially contain the flame retardant polyester resin composition. Resin compositions other than the flame retardant polyester resin composition forming the resin molded article vary depending on an intended molded article and can be, for example, polycarbonate resin compositions, polyamide resin compositions, polyphenylene ether resin compositions, polyacetal resin compositions, polyarylate resin compositions, polysulfone resin compositions, polyphenylene sulfide resin compositions, polyetherether ketone resin compositions, polyethersulfone resin compositions, polyetherimide resin compositions, polyolefin resin compositions, polyester carbonate resin compositions, thermoplastic polyurethane resin compositions, thermoplastic polyimide resin compositions, acrylic resin compositions, polystyrene resin compositions or the like.

Since the flame retardant polyester resin composition obtained by the present invention has a high level of flame retardancy and maintains its flammability after a long-term heat aging test even in a very thin molded article, it is used in a preferred manner for electric and electronic components in household electric appliances, OA equipment, etc., housings such as a fixing unit housing in parts for OA equipment, guide parts, shafts, precision parts in household electric appliances, lighting parts and the like that have a particularly complex shape.

### EXAMPLES

Now, the compositions of the present invention will be described by way of specific examples. It should be noted that the present invention is not limited thereto.

In the following, resins and materials that were used in Examples and Comparative Examples will be indicated.

Thermoplastic Polyester Resin (A):

polyethylene terephthalate (PET; manufactured by Kanebo Gohsen, Ltd., EFG-70) having a logarithmic viscosity (measured at 25° C. in a mixture solvent of phenol and tetrachloroethane in a weight ratio of 1:1; in the following, measured similarly) of 0.65 dl/g dried at 140° C. for 3 hours

polybutylene terephthalate (PBT; manufactured by Kolon Industries, Inc., KP-210)

Organophosphorous Flame Retardant (B): Produced in Manufacturing Example 1

Nitrogen Compound (C): Melamine Cyanurate (Manufactured by Nissan Chemical Industries, Ltd., MC440)

Stabilizer:

bisphenol A diglycidyl ether, butyl glycidyl ether (manufactured by Asahi Denka Co., Ltd., EP-22), and bis(2,6-di-t-butyl-4-methylphenyl)pentaerythritoldiphosphite (manufactured by Asahi Denka Co., Ltd.; trade name ADK STAB PEP-36)

pentaerythritoltetrakis[3-(3,5-di-t-butyl-4-hydroxyphenyl)propionate] (manufactured by Ciba Specialty Chemicals., IRGANOX1010)

### Manufacturing Example 1

Into a vertical polymerizer having a distilling tube, a rectifying tube, a nitrogen introducing tube and a stirrer, with respect to 100 parts by weight of 9,10-dihydro-9-oxa-10-phosphaphenanthrene-10-oxide represented by the general formula (2) below

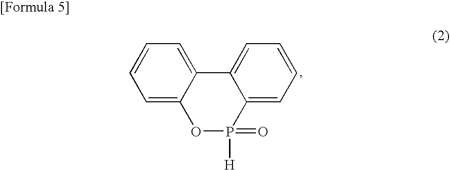

60 parts by weight of an equimolar amount of itaconic acid and 160 parts by weight of ethylene glycol with at least twice as many moles as the itaconic acid were added and heated gradually up to 120° C. to 200° C. in a nitrogen gas atmosphere, followed by stirring for about 10 hours, thus obtaining a phosphorous flame retardant solution. Then, 0.1 part by weight of antimony trioxide and 0.1 part by weight of zinc acetate were added to the obtained phosphorous flame retardant solution, and held in a vacuum reduced pressure at not greater than 1 Torr at 220° C., thus allowing a polycondensation reaction to occur while distilling ethylene glycol. After about 5 hours, it was determined that the reaction had stopped as the distillation amount of ethylene glycol dropped sharply. The obtained organophosphorous flame retardant (B) was a solid having a molecular weight of 7000 and had a phosphorus content of 8.3%.

The evaluation method in the instant description is as follows.

<Flame Retardancy>

According to the UL94 V-0 test, the initial flame retardancy and the flammability after a long-term heat aging test at 160° C. for 500 hours were evaluated with the obtained bar-shaped test pieces having 1/16 inch thickness and 1/32 thickness.

<Molding Processability>

In the molding processing of 127 mm×12.7 mm bar with a thickness of 1/16 inch using the obtained pellets, the molding processability was evaluated by the following criteria.

G: conforming article can be obtained without any problem in mold releasability or filling property.

F: poor mold release or short shot occurs.

<Extrusion Processability>

In the process of forming pellets from the mixture using an extruder, the extrusion processability was evaluated by the following criteria.

G: favorable pellets can be obtained without foaming, strand breakage or poor cutting.

F: foaming from dies, strand breakage or fracture at the time of cutting occurs.

### Examples 1 to 7

The materials (A) to (C) were blended in advance according to the blend composition (unit: part by weight) shown in Table 1. Using a vented 44 mm φ co-rotating twin screw extruder (manufactured by The Japan Steel Works, LTD.; TEX44), the above-noted mixture was supplied from a hopper hole, and melted and kneaded at a cylinder setting temperature of 250° C. to 280° C., thus obtaining pellets.

The obtained pellets were dried at 140° C. for 3 hours and then injection-molded at a cylinder temperature of 280° C. to 250° C. and a die temperature of 120° C. using an injection molding machine (clamping pressure: 35 tons) so as to obtain 127 mm×12.7 mm bar molded articles with a thickness of 1/16 inch and a thickness of 1/32 inch. Using the resultant test pieces, the flammability was evaluated by the above-mentioned criteria.

The results of evaluation in Examples 1 to 7 are shown in Table 1.

TABLE 1

| | | | Examples | | | | | | |
|---|---|---|---|---|---|---|---|---|---|
| | | | 1 | 2 | 3 | 4 | 5 | 6 | 7 |
| Blend | (A) thermoplastic polyester (part) | PET | 100 | 100 | 100 | 100 | 100 | 100 | 100 |
| formula | (B) organophosphorous flame retardant (part) | | 10 | 80 | 10 | 30 | 80 | 50 | 20 |
| | (C) nitrogen compound (part) | Melamine | 100 | 10 | 10 | 40 | 100 | 50 | 20 |
| | | cyanurate | | | | | | | |
| | Stabilizer (part) | EP-22 | 1.5 | 1.5 | 1.5 | 1.5 | 1.5 | 1.5 | 1.5 |
| | | PEP-36 | 1.5 | 1.5 | 1.5 | 1.5 | 1.5 | 1.5 | 1.5 |
| | | IRGANOX1010 | 1.5 | 1.5 | 1.5 | 1.5 | 1.5 | 1.5 | 1.5 |
| Properties | UL94 flammability <initial> | 1/16 inch | V-0 | V-0 | V-0 | V-0 | V-0 | V-0 | V-0 |
| | | thickness | | | | | | | |
| | | 1/32 inch | V-0 | V-0 | V-0 | V-0 | V-0 | V-0 | V-0 |
| | | thickness | | | | | | | |
| | UL94 flammability | 1/16 inch | V-0 | V-0 | V-0 | V-0 | V-0 | V-0 | V-0 |
| | <after heat aging test at 160° C. | thickness | | | | | | | |
| | for 500 hours> | 1/32 inch | V-0 | V-0 | V-1 | V-0 | V-0 | V-0 | V-0 |
| | | thickness | | | | | | | |
| | Molding processability | Judgment | G | G | G | G | G | G | G |
| | Extrusion processability | Judgment | G | G | G | G | G | G | G |

### Comparative Examples 1 to 6

According to the blend composition (unit: part by weight) shown in Table 2, the materials (A) to (C) were formed into pellets and injection-molded so as to obtain test pieces similarly to Examples, and the experiments were conducted by a similar evaluation method.

The results of evaluation in Comparative Examples 1 to 6 are shown in Table 2.

TABLE 2

| | | | Comparative Examples | | | | | |
|---|---|---|---|---|---|---|---|---|
| | | | 1 | 2 | 3 | 4 | 5 | 6 |
| Blend | (A) thermoplastic polyester (part) | PET | | 100 | 100 | 100 | 100 | 100 |
| formula | | PBT | 100 | | | | | |
| | (B) organophosphorous flame retardant (part) | | 7.0 | 7.0 | 5.0 | 90 | | 90 |
| | (C) nitrogen compound (part) | Melamine | | | 5.0 | | 110 | 110 |
| | | cyanurate | | | | | | |
| | Stabilizer (part) | EP-22 | 1.5 | 1.5 | 1.5 | 1.5 | 1.5 | 1.5 |
| | | PEP-36 | 1.5 | 1.5 | 1.5 | 1.5 | 1.5 | 1.5 |
| | | IRGANOX1010 | 1.5 | 1.5 | 1.5 | 1.5 | 1.5 | 1.5 |
| Properties | UL94 flammability <initial> | 1/16 inch | Not. V | Not. V | V-1 | V-0 | V-2 | V-0 |
| | | thickness | | | | | | |
| | | 1/32 inch | Not. V | Not. V | V-1 | V-1 | V-2 | V-0 |
| | | thickness | | | | | | |
| | UL94 flammability | 1/16 inch | Not. V | Not. V | Not. V | Not. V | Not. V | V-0 |
| | <after heat aging test at 160° C. | thickness | | | | | | |
| | for 500 hours> | 1/32 inch | Not. V | Not. V | Not. V | Not. V | Not. V | V-0 |
| | | thickness | | | | | | |
| | Molding processability | Judgment | G | G | G | F | F | F |
| | Extrusion processability | Judgment | G | G | G | G | F | F |

When the Examples and Comparative Examples are compared, it can be seen that the definition of the blend ratio of the organophosphorous flame retardant (B) and the nitrogen compound (C) with respect to the thermoplastic polyester resin (A) according to the present invention achieves excellent initial flammability and excellent flammability after the heat aging test at 160° C. for 500 hours at the 1/16 inch thickness.

### INDUSTRIAL APPLICABILITY

The flame retardant polyester resin composition according to the present invention is capable of achieving the UL94 V-0 rating in very thin molded articles such as those with a thickness of 1/16 inch and further maintaining the UL94 V-0 flammability at 1/16 inch thickness even after a long-term heat aging test at 160° C. for 500 hours. The flame retardant polyester resin composition according to the present invention can be used as a molding material of components in household electric appliances, electric components, parts for OA equipment and the like in a preferred manner and thus is industrially useful.

1. A flame retardant polyester resin composition comprising:
10 to 80 parts by weight of an organophosphorous flame retardant (B) represented by the general formula (1) below: 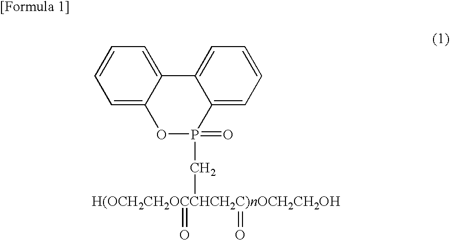
(where n=2 to 20)
and 10 to 100 parts by weight of a nitrogen compound (C) with respect to 100 parts by weight of a thermoplastic polyester resin (A);
wherein the flame retardant polyester resin composition has UL94 V-0 flame retardancy rating at 1/16 inch thickness.

2. The flame retardant polyester resin composition according to claim 1, which has UL94 V-0 flame retardancy rating at 1/16 inch thickness after a heat treatment at 160° C. for 500 hours.

3. The flame retardant polyester resin composition according to claim 1, wherein the thermoplastic polyester resin (A) is a polyalkylene terephthalate resin.

4. The flame retardant polyester resin composition according to claim 3, wherein the polyalkylene terephthalate resin is at least one resin selected from the group consisting of a polyethylene terephthalate resin and a polybutylene terephthalate resin.

5. The flame retardant polyester resin composition according to claim 1, wherein the organophosphorous flame retardant (B) has a molecular weight ranging from 4000 to 12000 and is a solid.

6. The flame retardant polyester resin composition according to claim 5, wherein the organophosphorous flame retardant (B) is obtained by, with respect to 9,10-dihydro-9-oxa-10-phosphaphenanthrene-10-oxide, mixing an equimolar amount of itaconic acid and ethylene glycol with at least twice as many moles as the itaconic acid and heating them between 120° C. and 200° C. in a nitrogen gas atmosphere, followed by stirring to obtain a phosphorous flame retardant solution, and then a polycondensation reaction.

7. The flame retardant polyester resin composition according to claim 1, wherein the nitrogen compound (C) is at least one selected from the group consisting of a melamine cyanuric acid adduct, a triazine compound of melamine and cyanuric acid, a tetrazole compound of melamine and cyanuric acid, melam, which is a dimer of melamine and melem, which is a trimer of melamine.

8. The flame retardant polyester resin composition according to claim 7, wherein the melamine cyanuric acid adduct has a mean particle diameter ranging from 0.01 to 250 μm.

9. The flame retardant polyester resin composition according to claim 1, further comprising 5 to 100 parts by weight of glass fibers with respect to 100 parts by weight of the thermoplastic polyester resin (A).

10. The flame retardant polyester resin composition according to claim 1, further comprising 1 to 60 parts by weight of at least one inorganic filler selected from the group consisting of carbon fibers, metallic fibers, aramid fibers, asbestos, potassium titanate whiskers, wollastonite, glass flakes, glass beads, talc, mica, clay, calcium carbonate, barium sulfate, titanium oxide and aluminum oxide, with respect to 100 parts by weight of the thermoplastic polyester resin (A).

11. The flame retardant polyester resin composition according to claim 1, further comprising 0.1 to 3.0 parts by weight of at least one thermal stabilizer selected from the group consisting of bisphenol A diglycidyl ether, butyl glycidyl ether, bis(2,6-di-t-butyl-4-methylphenyl)pentaerythritoldiphosphite, tris(2,4-di-t-butylphenyl)phosphite, 2,2-methylene bis(4,6-di-t-butylphenyl)octylphosphite and pentaerythritoltetrakis[3-(3,5-di-t-butyl-4-hydroxyphenyl)propionate], with respect to 100 parts by weight of the thermoplastic polyester resin (A).

12. A resin molded article comprising a flame retardant polyester resin composition comprising:
10 to 80 parts by weight of an organophosphorous flame retardant (B) represented by the general formula (1) below: 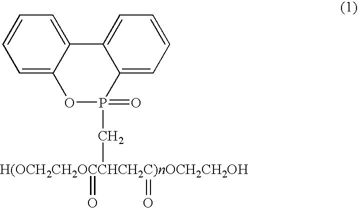
(where n=2 to 20)
and 10 to 100 parts by weight of a nitrogen compound (C) with respect to 100 parts by weight of a thermoplastic polyester resin (A);
wherein the flame retardant polyester resin composition has UL94 V-0 flame retardancy rating at 1/16 inch thickness.
